(19) United States
(12) Patent Application Publication
(10) Pub. No.: US 2005/0136275 A1
(43) Pub. Date: Jun. 23, 2005

(54) Packaging film

(76) Inventors: Toshiya Kamei, Gamagori (JP); Yukiyasu Itaya, Gamagori (JP)

Correspondence Address: BEYER WEAVER & THOMAS LLP, P.O. BOX 70250, OAKLAND, CA, 94612-0250, US

(21) Appl. No.: 10/984,424

(22) Filed: Nov. 8, 2004

(30) Foreign Application Priority Data
Dec. 19, 2003 (JP) 2003-421793
Jul. 26, 2004 (JP) 2004-217519

(51) Int. Cl. B32B 27/08; B32B 5/16

(52) U.S. Cl. 428/520; 428/331

(57) ABSTRACT

A packaging film of a single-layered or multi-layered kind includes an inner layer that comes to contact objects to be packaged and is made of a polyolefin resin composition with polyolefin resin containing three specified Components A, B and C each in a specified amount. Component A is one or more of partial esters or alkylene adducts of a specified kind. Component B is one or more of alkali salts of a specified kind. Component C may be one or more of oxidic inorganic particles, silicate inorganic particles and organic cross-link particles.

Priority is claimed on Japanese Patent Applications 2003-421793 filed Dec. 19, 2003 and 2004-217519 filed Jul. 26, 2004.

### BACKGROUND OF THE INVENTION

This invention relates to a packing film.

In recent years, single-layered and multi-layered packaging films including a layer of a synthetic resin material or a synthetic resin composition are widely being used for packaging products such as food items and medicaments. Packaging films using a polyolefin resin composition for forming the layer that comes to contact the objects to be packaged are used particularly frequently. Such a packaging film is required to have at least the layer that contacts the objects to be package to have antifog property in addition to its natural transparency property such that the packaged objects can be visible from outside. As the packaging operation comes to be automated, furthermore, smoothness and antiblocking property are also coming to be required in order to improve the adaptability to the packaging machine. The present invention relates to an improved packaging film that can satisfy all such requirements.

As disclosed in Japanese Patent Publications Tokkai 4-323228 and 2000-343655 and U.S. Pat. No. 5,346,944, it has been known to form a layer of a packaging film for contacting the objects to be packaged by using a polyolefin resin composition with a polyolefin resin containing inorganic particles and compounds such as polyoxyethylene alkylamine, polyoxyethylene alkylamide and aliphatic acid partial ester of aliphatic polyhydric alcohol in order to provide it with antifog property and antiblocking property. It has also been known to form such a layer by using a polyolefin resin composition containing organic particles and compounds such as polyoxyethylene alkylamine, polyoxyethylene alkylamide and aliphatic acid partial ester of aliphatic polyhydric alcohol, as disclosed in Japanese Patent Publications Tokkai 4-220436 and 8-59852.

These prior art packaging films, however, have the problem that the layer that comes to contact the objects to be packaged cannot sufficiently satisfy the requirement regarding the antifog and antiblocking properties without adversely affecting their natural transparency property.

### SUMMARY OF THE INVENTION

It is therefore an object of this invention to provide a packaging film which may be single-layered or multi-layered but has a layer that comes into contact with objects to be packaged and is formed so as to simultaneously possess superior antifog and antiblocking properties without adversely affecting its natural transparency property.

The present invention is based on the discovery made by the present inventors as a result of their diligent studies in view of the aforementioned problems of the prior art that a material obtained by causing a polyolefin resin to contain three specified components at a specified ratio should be used as the layer that comes to contact the objects to be packaged.

### DETAILED DESCRIPTION OF THE INVENTION

The invention relates to a single-layered or multi-layered packaging film having a layer that comes to contact the objects to be packaged and is made of a polyolefin resin composition obtained by causing polyolefin resin to contain Component A, Component B and Component C to be described below such that their total amount will be 0.15-12 weight % of the polyolefin resin composition.

In the above, Component A is one or more selected from the group consisting of partial esters of aliphatic trihydric-hexahydric alcohol and aliphatic monocarboxylic acid with 8-22 carbon atoms, alkylene oxide adducts of aliphatic monohydric alcohol with 8-22 carbon atoms, alkylene oxide adducts of aliphatic monocarboxylic acid with 8-22 carbon atoms and alkylene oxide adducts of partial ester of aliphatic trihydric-hexahydric alcohol and aliphatic monocarboxylic acid with 8-22 carbon atoms; Component B is one or more selected from the group consisting of alkali salts of alkyl sulfonic acid having alkyl group with 6-22 carbon atoms, alkali salts of alkyl aryl sulfonic acid having alkyl group with 2-22 carbon atoms and alkali salts of 1,2-bis(alkyloxycarbonyl)-1-ethane sulfonic acid having alkyl group with 2-22 carbon atoms; and Component C is one or more selected from the group consisting of oxidic inorganic particles, silicate inorganic particles and organic cross-link particles.

A packaging film embodying this invention is a single-layered or multi-layered film including a layer that comes to contact the objects to be packaged and is made of a polyolefin resin composition characterized as being formed with a polyolefin resin containing aforementioned Components A, B and C.

Examples of the polyolefin resin used for forming the polyolefin resin composition with which the layer that comes to contact the objects to be packaged include (1) α-olefin homopolymers such as polyethylene and polypropylene that can be obtained from one selected from α-olefins with 2-8 carbon atoms such as ethylene, propylene, 1-buten, 1-hexen, 4-methylpentene-1 and 1-octene; (2) α-olefin copolymers such as ethylene-propylene copolymers, ethylene-(1-butene) copolymers and ethylene-(1-hexene) copolymers that are obtained from two or more selected from aforementioned α-olefins with 2-8 carbon atoms; and (3) copolymers obtained from ethylene and vinyl acetate. Among the above, α-olefin homopolymers of aforementioned (1) and α-olefin copolymers of aforementioned (2) are preferred. Among the α-olefin copolymers of aforementioned (2), furthermore, copolymers of ethylene and α-olefin containing units consisting of α-olefin with 4-8 carbon atoms by 3.5-50 weight % are preferred. Of such α-olefin copolymers, those obtained by using any of homogeneous catalysts such as high activated ziegler catalyst and metallocene catalyst that are all well known and by a gas phase method or a solution polymerization method are preferable, and those having a density of 0.86-0.94 g/cm³ and MFR 0.01-20 g/10 minutes are particularly preferable. Two or more kinds of such polyolefin resins may be used by mixing them together.

Examples of Component A, to be used in the polyolefin resin composition for forming the layer that comes to contact the objects to be packaged, include (1) partial esters of aliphatic trihydric-hexahydric alcohol and aliphatic monocarboxylic acid with 8-22 carbon atoms; (2) alkylene oxide adducts of aliphatic monohydric alcohol with 8-22 carbon atoms; (3) alkylene oxide adducts of aliphatic monocarboxylic acid with 8-22 carbon atoms; (4) alkylene oxide adducts of partial ester of aliphatic trihydric-hexahydric alcohol and aliphatic monocarboxylic acid with 8-22 carbon atoms; and (5) mixtures of two or more selected from aforementioned (1)-(4).

Examples of aliphatic trihydric-hexahydric alcohols for obtaining partial esters of Component A include (1) aliphatic trihydric alcohols such as glycerol and trimethyrol propane; (2) aliphatic tetrahydric alcohols such as pentaerythritol, glucose, sorbitan, diglycerol and ethyleneglycol diglycerylether; (3) aliphatic pentahydric alcohols such as triglycerol and trimethyrol propane diglycerylether; and (4) aliphatic hexahydric alcohols such as sorbitol, tetraglycerol and dipentaerythritol. Of these, aliphatic trihyhdric or tetrahydric alcohols are preferred.

Examples of aliphatic monocarboxylic acid with 8-22 carbon atoms for obtaining partial esters of Component A include octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, eicosenoic acid, docosanoic acid, 2-ethylhexanoic acid and 3,5,5-trimethyl hexanoic acid. Among these, aliphatic monocarboxylic acids with 12-18 carbon atoms are preferred and dodecanoic acid, tetradecanoic acid and octadecenoic acid are particularly preferred.

The partial esters serving as Component A are obtained by appropriately combining aforementioned aliphatic trihydric-hexahydric alcohol and aliphatic monocarboxylic acid with 8-22 carbon atoms, having in any case at least one free hydroxyl group in the molecule but partial esters obtained from aliphatic trihydric or tetrahydric alcohol and aliphatic monocarbooxylic acid with 12-18 carbon atoms are preferable. Examples of such partial ester include glycerol monolaurate, sorbitan monolaurate and diglycerol monooleate.

Examples of alkylene oxide adduct of aliphatic monohydric alcohol with 8-22 carbon atoms include (1) aliphatic monohydric alcohol with 8-22 carbon atoms having one kind of alkylene oxide added and (2) aliphatic monohydric alcohol with 8-22 carbon atoms having two or more kinds of alkylene oxide added. Examples of aliphatic monohydric alcohol with 8-22 carbon atoms for producing such alkylene oxide adducts include octyl alcohol, nonyl alcohol, decyl alcohol, undecyl alcohol, dodecyl alcohol, tridecyl alcohol, tetradecyl alcohol, tentadecyl alcohol, hexadecyl alcohol, hexadecenyl alcohol, heptadecyl alcohol, octadecyl alcohol, octadecyl alcohol, octadecenyl alcohol, nonadecyl alcohol, eicosyl alcohol, eicosenyl alcohol, docosyl alcohol, 2-ethylhexyl alcohol and 3,5,5-trimethylhexyl alcohol. Among these, aliphatic monohydric alcohols with 12-18 carbon atoms are preferable and dodecyl alcohol, tetradecyl alcohol and octadecyl alcohol are particularly preferable. Examples of alkylene oxides used also for the production include alkylene oxides with 2-4 carbon atoms such as ethylene oxide, propylene oxide, 1,2-butylene oxide and 1,4-butylene oxide. When two or more kinds of such alkylene oxide are used, the form of addition of alkylene oxide to aliphatic monohydric alcohol with 8-22 carbon atoms may be random addition, block addition and randon-block addition. Of the aforementioned alkylene oxide adducts of aliphatic monohydric alcohol with 8-22 carbons atoms, those with average molecular weight of 200-1500 are preferable and those with average molecular weight of 300-1000 are particularly preferable.

Examples of alkylene oxide adduct of aliphatic monocarboxylic acid with 8-22 carbon atoms include (1) aliphatic monocarboxylic acid with 8-22 carbon atoms having one kind of alkylene oxide added and (2) aliphatic monocarboxylic acid with 8-22 carbon atoms having two or more kinds of alkylene oxide added. Examples of aliphatic monocarboxylic acid and alkylene oxides for producing such alkylene oxide adducts are the same as described above. Of such alkylene oxide adducts of aliphatic monocarboxylic acid with 8-22 carbons atoms, those with average molecular weight of 200-1500 are preferable and those with average molecular weight of 300-1000 are particularly preferable.

Examples of alkylene oxide adduct of partial ester of aliphatic trihydric-hexahydric alcohol and aliphatic monocarboxylic acid with 8-22 carbon atoms as Component A include (1) partial esters of aliphatic trihydric-hexahydric alcohol and aliphatic monocarboxylic acid with 8-22 carbon atoms having one kind of alkylene oxide added, and (2) partial esters of aliphatic trihydric-hexahydric alcohol and aliphatic monocarboxylic acid with 8-22 carbon atoms having two or more kinds of alkylene oxide added. Examples of aliphatic trihydric-hexahydric alcohol, aliphatic monocarboxylic acid with 8-22 carbon atoms, alkylene oxide and partial ester of aliphatic trihydric-hexahydric alcohol and aliphatic monocarboxylic acid with 8-22 carbon atoms for producing such alkylene oxide adducts are as described above. Of such alkylene oxide adducts of partial ester of aliphatic trihydric-hexahydric alcohol and aliphatic monocarboxylic acid with 8-22 carbon atoms as Component A, those with average molecular weight of 200-1700 are preferable and those with average molecular weight of 300-1200 are particularly preferable.

Partial esters of aliphatic trihydric or tetrahydric alcohol and aliphatic monocarboxylic acid with 12-18 carbon atoms are particular preferable as Component A but also preferable are partial esters of aliphatic trihydric-hexahydric alcohol and aliphatic monocarboxylic acid with 8-22 carbon atoms having a melting point equal to or below 40° C. as a whole. In the latter case, it may be a single partial ester with a melting point equal to or below 40° C. or a mixture of two or more partial esters such that the total melting point as a result of the mixing is 40° C. or below. In the latter case, mixtures containing a partial ester with a melting point 40° C. or below by 30 weight % or more are particularly preferable. Examples of partial esters having a melting point of 40° C. or below include diglycerol monooleate, diglycerol monolaurate, sorbitan monooleate and glycerol monooleate. Examples of the mixture include mixtures of diglycerol monostearate and diglycerol monooleate, those of diglycerol monostearate and glycerol monooleate, those of diglycerol monolaurate and glycerol monooleate and those of sorbitan monooleate and glycerol monooleate.

Examples of Component B to be used as the polyolefin resin composition for forming the layer that comes to contact the objects to be packaged include (1) alkali salts of alkyl sulfonic acid having alkyl group with 6-22 carbon atoms; (2) alkali salts of alkyl aryl sulfonic acid having alkyl group with 2-22 carbon atoms; (3) alkali salts of 1,2-bis(alkyloxycarbonyl)-1-ethane sulfonic acid having alkyl group with 2-22 carbon atoms; and (4) mixtures of two or more of aforementioned (1)-(3).

Examples of alkali salt of alkyl sulfonic acid having alkyl group with 6-22 carbon atoms serving as Component B include sodium hexylsulfonate, sodium octylsulfonate, sodium decylsulfonate, sodium dodecylsulfonate, lithium tetradecylsulfonate, lithium hexadecylsulfonate, lithium octadecylsulfonate, potassium eicosylsulfonate and potassium docosylsulfonate. Among these, alkali salts of alkylsulfonate having alkyl group with 12-18 carbon atoms are preferable.

Examples of alkali salts of alkyl aryl sulfonic acid having alkyl group with 2-22 carbon atoms serving as Component B include sodium ethylbenzene sulfonate, sodium propylbenzene sulfonate, sodium butylbenzene sulfonate, sodium dodecylbenzene sulfonate, potassium octadecyl benzene sulfonate, potassium eicosylbenzene sulfonate and sodium dibutylnaphthalene sulfonate. Among these, alkali salts of alkyl aryl sulfonic acid having alkyl group with 8-18 carbon atoms are preferable.

Examples of alkali salt of 1,2-bis(alkyloxycarbonyl)-1-ethane sulfonic acid having alkyl group with 2-22 carbon atoms serving as Component B include sodium 1,2-bis(ethyloxycarbonyl)-1 -ethane sulfonate, sodium 1,2-bis(propyloxycarbonyl)-1 -ethane sulfonate, sodium 1,2-bis(octyloxycarbonyl)-1-ethane sulfonate, lithium 1,2-bis(dodecyloxycarbonyl)-1-ethane sulfonate and lithium 1,2-bis(eicosyloxycarbonyl)-1-ethane sulfonate. Among these, alkali salts of 1,2-bis(alkyloxycarbonyl)-1-ethane sulfonate having alkyl group with 4-18 carbon atoms are preferable.

Particularly preferable as Component B are alkali salts of alkyl sulfonic acid having alkyl group with 12-18 carbon atoms.

Component C to be used for the polyolefin resin composition for forming the layer that comes to contact the objects to be packaged includes (1) oxidic inorganic particles, (2) silicate inorganic particles, (3) organic cross-link particles and (4) any mixtures of two or more of (1)-(3).

Examples of oxidic inorganic particles serving as Component C include silica, diatomaceous earth, alumina, iron oxide and ferrite. Among these, silica and diatomaceous earth are preferred, and silica is particularly preferred.

Examples of silicate inorganic particles serving as Component C include zeolite, talc, wollastonite, mica and clay. Among these, zeolite, talc and wollastonite are preferred and zeolite and talc are particularly preferred.

Examples of organic cross-link particles serving as Component C include cross-link silicone particles, cross-link polyamide particles, cross-link polytraizine particles, cross-link polyacryl particles and cross-link polystyrene particles. Among the above, cross-link silicone particles, cross-link polyacryl particles and cross-link styrene particles are preferred and cross-link polyacryl particles are particularly preferred.

Among the examples of Component C explained above, oxidic inoroganic particles and silicate inorganic particles are preferred and silica, zeolite and talc are particularly preferred. Although the invention does not impose any particular limiations on the oxidic inorganic particles, silicate inorganic particles and organic cross-link particles serving as Component C, those with average particle diameter of 0.5-10 μm are preferred and those with 1-5 μm are more preferred. Naturally produced minerals may be used as oxidic inorganic particles, silicate inorganic particles and organic cross-link particles serving as Component C. Artificially synthesized products may also be used. They may be used either directly without initially subjecting them to any particular processing or after carrying out a processing by means of a ball mill, an acid or a silane coupling agent.

A packaging film of this invention has a layer that comes to contact the objects to be packaged formed by a polyolefin resin composition of a polyolefin resin containing aforementioned Components A, B and C as necessary components such that their total contained amount will be 0.15-12 weight %. For this purpose, polyolefin resin compositions with polyolefin resin containing Component A in an amount of 0.05-5 weight %, Component B in an amount of 0.05-0.5 weight % and Component C in an amount of 0.05-2 weight % are preferred and those containing Component A in an amount of 0.3-4 weight %, Component B in an amount of 0.2-2.6 weight % and Component C in an amount of 0.1-1 weight % and Components A and B at a weight ratio of 60/40-80/20 and Component C and Components A and B at a weight ratio of 10/100-100/100 are particularly preferred.

The polyolefin resin compositions explained above for forming the layer that comes to contact the objects to be packaged may additionally contain agents of other kinds, depending on their purposes. Examples of such other agents include thermal stabilizers, anti-oxidants, neutralizing agents, lubricants, weatherproof agents, ultraviolet absorbing agents and antiblocking agents. The contents of such other agents should preferably be made as small as possible.

Such polyolefin resin compositions for forming the layer that comes to contact the objects to be packaged may themselves be prepared by any of known methods. Such well known methods include (1) methods of preliminarily preparing master pellets containing Components A, B and C at high concentrations by mixing Components A, B and C inside a mixer such as a tumbler blender or a henschel mixer and producing particles by melting and kneading together this mixture by means of an extruder such as a single-spindle extruder or a multiple-spindle extruder and obtaining a specified polyolefin resin composition by mixing these master pellets further with polyolefin resin; and (2) methods of mixing polyolefin resin with Components A, B and C in a mixer such as a tumbler blender or a henschel mixer and obtaining a specified polyolefin resin composition by producing particles while mixing them together and melting them by means of a kneader, a single-spindle extruder or a multiple-spindle extruder.

Packaging films of this invention may be molded by any of known methods including the inflation molding methods such as the air-cooling single step inflation molding, the air-cooling two-step inflation molding and the water-cooling inflation molding, and the T-die molding methods using straight-through manifold dies, coat hanger dies and their combinations. Methods of piling up molded films in layers include dry laminate process, sandwich laminate process, extrusion laminate process and coextrusion process. For the packaging films according to this invention, however, multi-layered films by a coextrusion process are preferred. For producing a layered packaging film, a polyurethane adhesive, an organotitanium anchor coat agent, an isocyanate anchor coat agent or an adhesive resin may be used. A molded film as explained above may be further drawn whether a single-layered or multi-layered packaging film is being produced. Examples of drawing method include sequential biaxial orientation, simultaneous biaxial orientation and tubular biaxial orientation.

As explained above, packaging films of this invention has a layer that comes to contact the objects to be packaged and has superior antifog and antiblocking properties without adversely affecting its natural transparency characteristic.

The invention is described next by way of the following five embodiments.

### EMBODIMENT (1)

A single-layered or multi-layered packaging film including a layer formed with polyolefin resin composition that comes to contact the objects to be packaged, this polyolefin resin composition comprising ethylene-(1-butene) copolymer (ethylene copolymerization ratio=95%, density=0.920 g/cm³, MFR=2.1 g/10 minutes) containing diglycerol monolaurate by 0.39 weight %, sodium dodecylsulfonate by 0.24 weight % and silica (with average particle diameter 4.0 μm) by 0.57 weight %.

### EMBODIMENT (2)

A single-layered or multi-layered packaging film including a layer formed with polyolefin resin composition that comes to contact the objects to be packaged, this polyolefin resin composition comprising ethylene-(1-hexene) copolymer (ethylene copolymerization ratio=96%, density=0.930 g/cm³, MFR=1.0 g/10 minutes) containing mixture of diglycerol monostearate and diglycerol monooleate at weight ratio of 65/35 by 3.50 weight %, sodium tetradecylsulfonate by 1.20 weight % and silica (with average particle diameter 3.0 μm) by 0.70 weight %.

### EMBODIMENT (3)

A single-layered or multi-layered packaging film including a layer formed with polyolefin resin composition that comes to contact the objects to be packaged, this polyolefin resin composition comprising ethylene-acetic acid copolymer (ethylene copolymerization ratio=98%, MFR=1.5 g/10 minutes) containing mixture of diglycerol monostearate and glycerol monooleate at weight ratio of 50/50 by 1.40 weight %, sodium pentadecylsulfonate by 0.60 weight % and zeolite (with average particle diameter 4.0 μm) by 0.80 weight %.

### EMBODIMENT (4)

A single-layered or multi-layered packaging film including a layer formed with polyolefin resin composition that comes to contact the objects to be packaged, this polyolefin resin composition comprising ethylene-propylene copolymer (ethylene copolymerization ratio=96%, density=0.90 g/cm³, MFR =8.0 g/10 minutes) containing mixture of diglycerol monolaurate and glycerol monooleate at weight ratio of 70/30 by 3.80 weight %, sodium hexadecylsulfonate by 2.10 weight % and talc (with average particle diameter 2.0 μm) by 0.90 weight %.

### EMBODIMENT (5)

A single-layered or multi-layered packaging film including a layer formed with polyolefin resin composition that comes to contact the objects to be packaged, this polyolefin resin composition comprising propylene (density=0.90 g/cm³, MFR=2.4 g/10 minutes) containing mixture of sorbitan monolaurate and glycerol monooleate at weight ratio of 70/30 by 0.78 weight %, mixture of sodium tetradecylsulfonate and sodium pentadecylsulfonate at weight ratio of 50/50 by 0.32 weight % and talc (with average particle diameter 4.5 μm) by 0.20 weight %.

The invention is described next by way of test examples in order to more clearly explain its structure and effects but it goes without saying that these examples are not intended to limit the scope of the invention. In what follows, “parts” will indicate “weight parts” and “%” will indicate “weight %.”

Part 1 (Production of Packaging Films)

### TEST EXAMPLE 1

After ethylene-(1-butene) copolymer (ethylene copolymerization ratio=95%, density=0.920 g/cm³, MFR=2.1 g/10 minutes) (88 parts), diglycerol monolaurate (3.9 parts), sodium dodecylsulfonate (2.4 parts) and silica (with average particle diameter 4.0 μm) (5.7 parts) were placed inside a tumbler blender and mixed, they were further melted and kneaded by means of a two-spindle extruder to obtain master pellets of polyolefin resin composition. These master pellets (10 parts) and aforementioned ethylene-(1-butene) copolymer (ethylene copolymerization ratio=95%, density=0.920 g/cm³, MFR=2.1 g/10 minutes) (90 parts) were mixed inside the tumbler blender and supplied to a inflation molder (TKN-40 produced by Chubu Kagaku Kikai Seisakusho) with dies of 75 mmφ and lip gap 0.5 mm for inflation molding under the conditions of extrusion temperature of polyolefin resin composition=200° C. and BUR=1.8 to obtain a single-layered packaging film with thickness 40 μm.

### TEST EXAMPLES 2-27 AND COMPARISON EXAMPLES 1-6

Packaging films of Test Examples 2-27 and Comparison Examples 1-6 were similarly prepared as shown in Table 1.

TABLE 1

| | Components contained by polyolefin resin | | | | | | Kind of |
|---|---|---|---|---|---|---|---|
| | Comp A | Comp B | Comp C | | | | polyolefin |
| | *1 | *2 | *3 | *4 | *5 | *6 | resin |
| Test Example | | | | | | | |
| 1 | A-1/0.39 | B-1/0.24 | C-1/0.57 | 1.20 | 62/38 | 90 | E-1 |
| 2 | A-2/3.50 | B-2/1.20 | C-2/0.70 | 5.40 | 74/26 | 15 | E-2 |
| 3 | A-3/1.40 | B-3/0.60 | C-3/0.80 | 2.80 | 70/30 | 40 | E-3 |
| 4 | A-4/3.80 | B-4/2.10 | C-4/0.90 | 6.80 | 64/36 | 15 | E-4 |
| 5 | A-5/0.78 | B-5/0.32 | C-5/0.20 | 1.30 | 71/29 | 18 | E-5 |
| 6 | A-6/3.96 | B-6/2.64 | C-6/0.66 | 7.26 | 60/40 | 10 | E-6 |
| 7 | A-7/0.78 | B-7/0.22 | C-7/0.95 | 1.95 | 78/22 | 95 | E-1 |
| 8 | A-8/0.30 | B-8/0.20 | C-8/0.30 | 0.80 | 60/40 | 60 | E-2 |
| 9 | A-9/2.80 | B-9/1.20 | C-9/0.60 | 4.60 | 70/30 | 15 | E-3 |
| 10 | A-10/1.02 | B-10/0.48 | C-6/0.45 | 1.95 | 68/32 | 30 | E-4 |
| 11 | A-11/1.48 | B-11/0.52 | C-7/0.98 | 2.98 | 74/26 | 49 | E-5 |
| 12 | A-12/0.96 | B-12/0.24 | C-8/0.84 | 2.04 | 80/20 | 70 | E-1 |
| 13 | A-13/0.63 | B-13/0.32 | C-9/0.76 | 1.71 | 66/34 | 80 | E-2 |
| 14 | A-14/0.10 | B-14/0.12 | C-10/0.31 | 0.53 | 45/55 | 141 | E-6 |
| 15 | A-15/4.5 | B-15/0.50 | C-10/0.3 | 5.30 | 90/10 | 6 | E-1 |
| 16 | A-16/0.06 | B-16/0.06 | C-11/0.06 | 0.18 | 50/50 | 50 | E-2 |
| 17 | A-17/4.8 | B-17/3.5 | C-11/1.5 | 9.80 | 58/42 | 18 | E-4 |
| 18 | A-18/3.3 | B-18/5.0 | C-12/1.9 | 10.2 | 40/60 | 23 | E-3 |
| 19 | A-19/1.7 | B-19/0.30 | C-13/1.2 | 3.2 | 85/15 | 60 | E-4 |
| 20 | A-20/3.44 | B-20/2.81 | C-14/0.50 | 6.75 | 55/45 | 8 | E-5 |
| 21 | A-21/2.4 | B-21/5.6 | C-15/0.24 | 8.24 | 30/70 | 3 | E-1 |
| 22 | A-22/0.98 | B-22/0.02 | C-16/1.75 | 2.75 | 98/2 | 175 | E-2 |
| 23 | A-23/2.8 | B-23/5.2 | C-17/0.32 | 8.32 | 35/65 | 4 | E-5 |
| 24 | A-24/4.8 | B-24/0.20 | C-18/1.80 | 6.80 | 96/4 | 36 | E-6 |
| 25 | A-25/1.50 | B-25/0.04 | C-19/0.30 | 1.84 | 97/3 | 19 | E-2 |
| 26 | A-26/6.0 | B-26/3.00 | C-20/0.70 | 9.70 | 67/33 | 78 | E-3 |
| 27 | A-27/2.00 | B-27/2.00 | C-21/2.20 | 6.20 | 50/50 | 55 | E-4 |
| Comparison Example | | | | | | | |
| 1 | —/— | B-1/0.24 | C-1/0.57 | — | — | — | E-1 |
| 2 | A-1/0.39 | —/— | C-1/0.57 | — | — | — | E-1 |
| 3 | A-1/0.39 | B-1/0.24 | —/— | — | — | — | E-1 |
| 4 | A-1/0.04 | B-1/0.02 | C-1/0.06 | 0.12 | 67/33 | 100 | E-1 |
| 5 | A-1/4.29 | B-1/2.64 | C-1/6.27 | 13.2 | 62/38 | 90 | E-1 |
| 6 | a-1/0.39 | B-1/0.24 | C-1/0.57 | 1.20 | 62/38 | 90 | E-1 |

In Table 1
*1: Kind/concentration (weight %) of Component A in polyolefin resin composition;
*2: Kind/concentration (weight %) of Component B in polyolefin resin composition;
*3: Kind/concentration (weight %) of Component C in polyolefin resin composition;
*4: Total concentration (weight %) of Components A, B and C;
*5: Weight ratio of Component A to Component B;
*6: Ratio (part) of Component C per 100 parts of Components A and B;
A-1: Diglycerol monolaurate (melting point = 20° C.);
A-2: Mixture of diglycerol monostearate (melting point = 55° C.) and diglycerol monooleate (melting point = 2° C.) at weight ratio of 65/35;
A-3: Mixture of diglycerol monostearate (melting point = 55° C.) and glycerol monooleate (melting point = 12° C.) at weight ratio of 50/50;
A-4: Mixture of diglycerol monolaurate (melting point = 20° C.) and glycerol monooleate (melting point = 12° C.) at weight ratio of 70/30;
A-5: Mixture of sorbitan monooleate (melting point = 8° C.) and glycerol monooleate (melting point = 12° C.) at weight ratio of 70/30;
A-6: Mixture of glycerol monooctanate (melting point = 35° C.) and diglycerol monolaurate (melting point = 20° C.) at weight ratio of 15/85;
A-7: Mixture of glycerol monoerucate (melting point = 50° C.) and diglycerol monolaurate (melting point = 20° C.) at weight ratio of 10/90;
A-8: Mixture of tetraglycerol monooctanate (melting point = 25° C.) and diglycerol monolaurate (melting point = 20° C.) at weight ratio of 15/85;
A-9: Mixture of tetraglycerol monoerucate (melting point = 50° C.) and diglycerol monolaurate (melting point = 20° C.) at weight ratio of 10/90;
A-10: Mixture of glycerol monolaurate (melting point = 55° C.) and diglycerol monolaurate (melting point = 20° C.) at weight ratio of 10/90;
A-11: Mixture of tetraglycerol monooleate (melting point = 25° C.) and diglycerol monolaurate (melting point = 20° C.) at weight ratio of 10/90;
A-12: Ethylene oxide adduct of octyl alcohol (average molecular weight = 450, melting point = 5° C.);
A-13: Ethylene oxide adduct of docosenyl alcohol (average molecular weight = 1200, melting point = 50° C.);
A-14: Diglycerol monostearate (melting point = 55° C.);
A-15: Sorbitan monostearate (melting point = 60° C.);
A-16: Mixture of diglycerol monostearate (melting point = 55° C.) and glycerol monostearate (melting point = 70° C.) at weight ratio of 50/50;
A-17: Mixture of sorbitan monostearate (melting point = 60° C.) and glycerol monostearate (melting point = 70° C.) at weight ratio of 50/50;
A-18: Ethylene oxide adduct of octanic acid (average molecular weight = 450, melting point = 5° C.);
A-19: Ethylene oxide adduct of docosenic acid (average molecular weight = 1200, melting point = 50° C.);
A-20: Ethylene oxide adduct of glycerol monooctanate (average molecular weight = 900, melting point = 30° C.);
A-21: Diglycerol monooctanate (melting point = −8° C.);
A-22: Ethylene oxide adduct of octadecenyl alcohol (average molecular weight = 900, melting point = 2° C.);
A-23: Ethylene oxide adduct of dodecanoic acid (average molecular weight = 350, melting point = 7° C.);
A-24: Ethylene oxide adduct of sorbitan monooleate (average molecular weight = 950, melting point = −10° C.);
A-25: Ethylene oxide adduct of glycerol monoerucate (average molecular weight = 1000, melting point = 30° C.);
A-26: Ethylene oxide adduct of tetraglycerol monooctanate (average molecular weight = 1200, melting point = 25° C.);
A-27: Ethylene oxide adduct of tetraglycerol monoerucate (average molecular weight = 1400, melting point = 25° C.);
a-1: N,N-bis(2-hydroxyethyl) dodecylamine;
B-1: Sodium dodecylsulfonate;
B-2: Sodium tetradecylsulfonate;
B-3: Sodium pentadecylsulfonate;
B-4: Sodium Hexadecylsulfonate;
B-5: Mixture of sodium tetradecylsulfonate and sodium pentadecylsulfonate at weight ratio of 50/50;
B-6: Lithium dodecylsulfonate;
B-7: Lithium octadecylsulfonate;
B-8: Potassium dodecylsulfonate;
B-9: Potassium octadecylsulfonate;
B-10: Sodium hexylsulfonate;
B-11: Sodium docosylsulfonate;
B-12: Sodium docosylbenzene sulfonate;
B-13: Mixture of potassium diethylnaphthalene sulfonate and potassium docosylbenzene sulfonate at weight ratio of 50/50;
B-14: Potassium tetradecylsulfonate;
B-15: Lithium dodecylbenzene sulfonate;
B-16: Potassium 1,2-bis(octyloxycarbonyl)-1-ethane sulfonate;
B-17: Mixture of sodium dodecylbenzene sulfonate and sodium 1,2-bis(octyloxycarbonyl)-1-ethane sulfonate at weight ratio of 50/50;
B-18: Potassium 1,2-bis(ethyloxycarbonyl)-1-ethane sulfonate;
B-19: Sodium 1,2-bis(dodecyloxycarbonyl)-1-ethane sulfonate;
B-20: Mixture of lithium 1,2-bis(ethyloxycarbonyl)-1-ethane sulfonate and lithium 1,2-bis(dodecyloxycarbonyl)-1-ethane sulfonate at weight ratio of 50/50;
B-21: Lithium octylsulfonate;
B-22: Potassium hexylbenzen sulfonate;
B-23: Lithium dibutylnaphthalene sulfonate;
B-24: Mixture of lithium octylsulfonate and lithium dibutylnaphthalene sulfonate at weight ratio of 50/50;
B-25: Sodium octylsulfonate;
B-26: Potassium 1,2-bis(docosyloxycarbonyl)-1-ethane sulfonate;
B-27: Mixture of lithium octylsulfonate and lithium 1,2-bis(docosyloxycarbonyl)-1-ethane sulfonate;
C-1: Silica (average particle diameter = 4.0 μm);
C-2: Silica (average particle diameter = 3.0 μm);
C-3: Zeolite (average particle diameter = 4.0 μm);
C-4: Talc (average particle diameter = 2.0 μm);
C-5: Talc (average particle diameter = 4.5 μm);
C-6: Mixture of silica (average particle diameter = 4.0 μm) and zeolite (average particle diameter = 4.0 μm) at weight ratio of 20/80;
C-7: Mixture of silica (average particle diameter = 3.0 μm) and zeolite (average particle diameter = 4.0 μm) at weight ratio of 70/30;
C-8: Mixture of silica (average particle diameter = 4.0 μm) and talc (average particle diameter = 2.0 μm) at weight ratio of 50/50;
C-9: Mixture of talc (average particle diameter = 4.5 μm) and zeolite (average particle diameter = 4.0 μm) at weight ratio of 50/50;
C-10: Diatomaceous earth (average particle diameter = 6.0 μm);
C-11: Wollastonite (average particle diameter = 4.0 μm);
C-12: Mixture of silica (average particle diameter = 4.0 μm) and diatomaceous earth (average particle diameter = 6.0 μm) at weight ratio of 50/50;
C-13: Mixture of zeolite (average particle diameter = 4.0 μm) and diatomaceous earth (average particle diameter = 6.0 μm) at weight ratio of 50/50;
C-14: Mixture of talc (average particle diameter = 4.5 μm) and wollastonte (average particle diameter = 4.0 μm) at weight ratio of 50/50;
C-15: Alumina (average particle diameter = 2.0 μm);
C-16: Mica (average particle diameter = 7.0 μm);
C-17: Cross-link silicone particles (average particle diameter = 2.0 μm);
C-18: Cross-link polyacryl particles (average particle diameter = 4.0 μm);
C-19: Mixture of silica (average particle diameter = 4.0 μm) and mica (average particle diameter = 7.0 μm) at weight ratio of 50/50;
C-20: Mixture of zeolite (average particle diameter = 4.0 μm) and cross-link silicone particles (average particle diameter = 2.0 μm) at weight ratio of 50/50;
C-21: Mixture of talc (average particle diameter = 4.5 μm) and cross-link polyacryl particles (average particle diameter = 4.0 μm) at weight ratio of 50/50;
E-1: Ethylene-(1-butene) copolymer (ethylene copolymerization ratio = 95%, density = 0.920 g/cm³, MFR = 2.1 g/10 minutes);
E-2: Ethylene-(1-hexene) copolymer (ethylene copolymerization ratio = 96%, density = 0.930 g/cm³, MFR = 1.0 g/10 minutes);
E-3: Ethylene-vinyl acetate copolymer (ethylene copolymerization ratio = 98%, MFR = 1.5 g/10 minutes);
E-4: Ethylene-propylene copolymer (ethylene copolymerization ratio = 96%, density = 0.90 g/cm³, MFR = 8.0 g/10 minutes);
E-5: Polypropylene (density = 0.90 g/cm³, MFR = 2.4 g/10 minutes);
E-6: Polyethylene (density = 0.927 g/cm³, MFR = 4.0 g/10 minutes).

Part 2 (Evaluation of Packaging Films)

The packaging films prepared in Part 1 were evaluated as followed regarding their transparency, antifog property, smoothness and antiblocking property. The results are summarized in Table 2.

TABLE 2

| | Transparency | | Antifog property | | Smoothness | | Antiblocking property | |
|---|---|---|---|---|---|---|---|---|
| | After 24 | After 4 | After 24 | After 4 | After 24 | After 4 | After 24 | After 4 |
| | hours | weeks | hours | weeks | hours | weeks | hours | weeks |
| Test Example | | | | | | | | |
| 1 | A | A | A | A | A | A | A | A |
| 2 | A | A | A | A | A | A | A | A |
| 3 | A | A | A | A | A | A | A | A |
| 4 | A | A | A | A | A | A | A | A |
| 5 | A | A | A | A | A | A | A | A |
| 6 | A | A | A | A | A | A | A | A |
| 7 | A | A | A | A | A | A | A | A |
| 8 | A | A | A | A | A | A | A | A |
| 9 | A | A | A | A | A | A | A | A |
| 10 | A | B | A | A | A | A | A | A |
| 11 | A | A | A | A | A | A | A | B |
| 12 | A | B | A | A | A | A | A | A |
| 13 | A | B | A | A | A | A | A | A |
| 14 | B | B | A | A | A | A | A | A |
| 15 | A | A | A | A | B | B | A | A |
| 16 | A | A | A | A | B | B | A | A |
| 17 | A | A | A | A | B | B | A | A |
| 18 | A | A | A | A | B | B | A | A |
| 19 | A | A | A | A | A | A | B | B |
| 20 | A | A | A | A | A | A | B | B |
| 21 | A | A | A | A | B | B | B | B |
| 22 | B | B | B | B | A | A | A | A |
| 23 | A | A | A | A | B | B | B | B |
| 24 | A | A | A | A | B | B | B | B |
| 25 | A | A | A | A | B | B | B | B |
| 26 | A | A | A | A | B | B | B | B |
| 27 | B | B | B | B | A | A | A | A |
| Comparison Example | | | | | | | | |
| 1 | A | A | D | D | C | C | B | B |
| 2 | A | A | C | C | B | B | C | C |
| 3 | A | A | B | B | D | D | D | D |
| 4 | A | A | D | D | D | D | D | D |
| 5 | D | D | B | B | D | D | D | D |
| 6 | C | C | C | D | C | C | C | C |

Transparency

After the packaging films prepared in Part 1 were each adjusted under the condition of relative humidity 65% for 24 hours at 20° C., haze was measured and evaluated according to the following standards. Similar evaluations were also made on the films kept for 4 weeks under the condition of relative humidity 50% at 40° C.
A: Less than 5% (excellent transparency)
B: 5% or greater but less than 10% (good transparency)
C: 10% or greater but less than 15% (poor transparency)
D: 15% or greater (very poor transparency)

Antifog Property

After the packaging films prepared in Part 1 were each adjusted under the condition of relative humidity 65% for 24 hours at 20° C., a beaker containing water at 20° C. was covered with each film such that the test surface will face inside and left for one hour in an environment of temperature at 5° C. Water drops which become attached to the test surface were observed and evaluated as follows. Similar evaluations were made on the films kept for 4 weeks at 40° C. under the condition of relative humidity of 50%.
A: Transparent without water drops (excellent antifog property)
B: Transparent although with large water drops (good antifog property)
C: Somewhat non-transparent with water drops (poor antifog property)
D: Not transparent with small water drops (very poor antifog property)

Smoothness

After the packaging films prepared in Part 1 were each adjusted under the condition of relative humidity 65% for 24 hours at 20° C., a friction tester (Type TR produced by Toyo Seiki Seisakusho, Ltd.) was used to measure the coefficient of kinetic friction according to ASTM-D-1894 and the measured values were evaluated as follows.
A: 0.05 or greater and less than 0.25 (excellent smoothness)
B: 0.25 or greater and less than 0.35 (good smoothness)
C: 0.35 or greater and less than 0.45 (poor smoothness)
D: 0.45 or greater (very poor smoothness and not practical)

Antiblocking Property

Two pieces of length 80 mm and width 50 mm were cut out from each of the packaging films immediately after they were prepared in Part 1 and they were placed one above the other such that portions of test surfaces with length 50 mm and width 50 mm would over lap and contact each other. After a load of 10 kg/cm² was applied for 48 hours. at 40° C. on the mutually contacting test surfaces, the load was removed and a tensile tester (tradename of Autograph AG-G produced by Shimadzu Corporation) was used to measure the force necessary to separate the two sheets by pulling their edges in mutually opposites shearing directions of the sheets. The measured values were evaluated as follows. Similar evaluations were made also on sheets from films kept for 4weeks under the condition of relative humidity of 50% at 40° C.
A: Less than 0.2 N/cm² (excellent antiblocking property)
B: 0.2 N/cm² or greater and less than 0.4 N/cm² (good antiblocking property)
C: 0.4 N/cm² or greater and less than 0.6 N/cm² (poor antiblocking property)
D: 0.6 N/cm² or greater (very poor antiblocking property)
   Part 3 (Production of Packaging Films)

### TEST EXAMPLE 28

After ethylene-(1-butene) copolymer (ethylene copolymerization ratio=95%, density=0.920 g/cm³, MFR=2.1 g/10 minutes) 88 parts), diglycerol monolaurate (3.9 parts), sodium dodecylsulfonate (2.4 parts) and silica (with average particle diameter 4.0 μm) (5.7 parts) were placed inside a tumbler blender and mixed, they were further melted and kneaded by means of a two-spindle extruder to obtain master pellets of polyolefin resin compositon. These master pellets (10 parts) and aforementioned ethylene-(1-butene) copolymer (ethylene copolymerization ration=95%, density=0.920 g/cm³, MFR=2.1 g/10 minutes) (90 parts) were mixed inside the tumbler blender to obtain the polyolefin resin composition for forming the layer that comes to contact the objects to be packaged. A coextruded three-layer film with thickness 60 μm was obtained by molding this polyolefin resin composition to form the inner layer for contacting the objects to be packaged and the aforementioned ethylene-(1-butene) copolymer (ethylene copolymerization ratio=95%, density=0.920 g/cm³, MFR=2.1 g/10 minutes) to form the middle layer and the outer layer while cooling to 30° C. The ratio of thickness for the inner, middle and outer layers was 1/4/1.

### TEST EXAMPLES 29-54 AND COMPARISON EXAMPLES 7-12

Packaging films of Test Examples 29-54 and Comparison Examples 7-12 were similarly produced. Their details are shown in Table 3 wherein symbols defined in connection with Table 1 are used.

Part 4 (Evaluation of Packaging Films)

The packaging films prepared in Part 3 were evaluated as done in Part 2 for the packaging films prepared in Part 1 regarding their transparency, antifog property, smoothness and antiblocking property. The results are summarized in Table 4.

TABLE 3

| | Components contained by polyolefin resin | | | | | | Kind of |
|---|---|---|---|---|---|---|---|
| | Comp A | Comp B | Comp C | | | | polyolefin |
| | *1 | *2 | *3 | *4 | *5 | *6 | resin |
| Test Example | | | | | | | |
| 28 | A-1/0.39 | B-1/0.24 | C-1/0.57 | 1.20 | 62/38 | 90 | E-1 |
| 29 | A-2/3.50 | B-2/1.20 | C-2/0.70 | 5.40 | 74/26 | 15 | E-2 |
| 30 | A-3/1.40 | B-3/0.60 | C-3/0.80 | 2.80 | 70/30 | 40 | E-3 |
| 31 | A-4/3.80 | B-4/2.10 | C-4/0.90 | 6.80 | 64/36 | 15 | E-4 |
| 32 | A-5/0.78 | B-5/0.32 | C-5/0.20 | 1.30 | 71/29 | 18 | E-5 |
| 33 | A-6/3.96 | B-6/2.64 | C-6/0.66 | 7.26 | 60/40 | 10 | E-6 |
| 34 | A-7/0.78 | B-7/0.22 | C-7/0.95 | 1.95 | 78/22 | 95 | E-1 |
| 35 | A-8/0.30 | B-8/0.20 | C-8/0.30 | 0.80 | 60/40 | 60 | E-2 |
| 36 | A-9/2.80 | B-9/1.20 | C-9/0.60 | 4.60 | 70/30 | 15 | E-3 |
| 37 | A-10/1.02 | B-10/0.48 | C-6/0.45 | 1.95 | 68/32 | 30 | E-4 |
| 38 | A-11/1.48 | B-11/0.52 | C-7/0.98 | 2.98 | 74/26 | 49 | E-5 |
| 39 | A-12/0.96 | B-12/0.24 | C-8/0.84 | 2.04 | 80/20 | 70 | E-1 |
| 40 | A-13/0.63 | B-13/0.32 | C-9/0.76 | 1.71 | 66/34 | 80 | E-2 |
| 41 | A-14/0.10 | B-14/0.12 | C-10/0.31 | 0.53 | 45/55 | 141 | E-6 |
| 42 | A-15/4.5 | B-15/0.50 | C-10/0.3 | 5.30 | 90/10 | 6 | E-1 |
| 43 | A-16/0.06 | B-16/0.06 | C-11/0.06 | 0.18 | 50/50 | 50 | E-2 |
| 44 | A-17/4.8 | B-17/3.5 | C-11/1.5 | 9.80 | 58/42 | 18 | E-4 |
| 45 | A-18/3.3 | B-18/5.0 | C-12/1.9 | 10.2 | 40/60 | 23 | E-3 |
| 46 | A-19/1.7 | B-19/0.30 | C-13/1.2 | 3.2 | 85/15 | 60 | E-4 |
| 47 | A-20/3.44 | B-20/2.81 | C-14/0.50 | 6.75 | 55/45 | 8 | E-5 |
| 48 | A-21/2.4 | B-21/5.6 | C-15/0.24 | 8.24 | 30/70 | 3 | E-1 |
| 49 | A-22/0.98 | B-22/0.02 | C-16/1.75 | 2.75 | 98/2 | 175 | E-2 |
| 50 | A-23/2.8 | B-23/5.2 | C-17/0.32 | 8.32 | 35/65 | 4 | E-5 |
| 51 | A-24/4.8 | B-24/0.20 | C-18/1.80 | 6.80 | 96/4 | 36 | E-6 |
| 52 | A-25/1.50 | B-25/0.04 | C-19/0.30 | 1.84 | 97/3 | 19 | E-2 |
| 53 | A-26/6.0 | B-26/3.00 | C-20/0.70 | 9.70 | 67/33 | 78 | E-3 |
| 54 | A-27/2.00 | B-27/2.00 | C-21/2.20 | 6.20 | 50/50 | 55 | E-4 |
| Comparison Example | | | | | | | |
| 7 | —/— | B-1/0.24 | C-1/0.57 | — | — | — | E-1 |
| 8 | A-1/0.39 | —/— | C-1/0.57 | — | — | — | E-1 |
| 9 | A-1/0.39 | B-1/0.24 | —/— | — | — | — | E-1 |
| 10 | A-1/0.04 | B-1/0.02 | C-1/0.06 | 0.12 | 67/33 | 100 | E-1 |
| 11 | A-1/4.29 | B-1/2.64 | C-1/6.27 | 13.2 | 62/38 | 90 | E-1 |
| 12 | a-1/0.39 | B-1/0.24 | C-1/0.57 | 1.20 | 62/38 | 90 | E-1 |

TABLE 4

| | Transparency | | Antifog property | | Smoothness | | Antiblocking property | |
|---|---|---|---|---|---|---|---|---|
| | After 24 | After 4 | After 24 | After 4 | After 24 | After 4 | After 24 | After 4 |
| | hours | weeks | hours | weeks | hours | weeks | hours | weeks |
| Test Example | | | | | | | | |
| 28 | A | A | A | A | A | A | A | A |
| 29 | A | A | A | A | A | A | A | A |
| 30 | A | A | A | A | A | A | A | A |
| 31 | A | A | A | A | A | A | A | A |
| 32 | A | A | A | A | A | A | A | A |
| 33 | A | A | A | A | A | A | A | A |
| 34 | A | A | A | A | A | A | A | A |
| 35 | A | A | A | A | A | A | A | A |
| 36 | A | A | A | A | A | A | A | A |
| 37 | A | B | A | A | A | A | A | A |
| 38 | A | A | A | A | A | A | A | B |
| 39 | A | B | A | A | A | A | A | A |
| 40 | A | B | A | A | A | A | A | A |
| 41 | B | B | A | A | A | A | A | A |
| 42 | A | A | A | A | B | B | A | A |
| 43 | A | A | A | A | B | B | A | A |
| 44 | A | A | A | A | B | B | A | A |
| 45 | A | A | A | A | B | B | A | A |
| 46 | A | A | A | A | A | A | B | B |
| 47 | A | A | A | A | A | A | B | B |
| 48 | A | A | A | A | B | B | B | B |
| 49 | B | B | B | B | A | A | A | A |
| 50 | A | A | A | A | B | B | B | B |
| 51 | A | A | A | A | B | B | B | B |
| 52 | A | A | A | A | B | B | B | B |
| 53 | A | A | A | A | B | B | B | B |
| 54 | B | B | B | B | A | A | A | A |
| Comparison Example | | | | | | | | |
| 7 | A | A | D | D | C | C | B | B |
| 8 | A | A | C | C | B | B | C | C |
| 9 | A | A | B | B | D | D | D | D |
| 10 | A | A | D | D | D | D | D | D |
| 11 | D | D | B | B | D | D | D | D |
| 12 | C | C | C | D | C | C | C | C |

1. A packaging film which is single-layered or multi-layered, including an inner layer that comes to contact objects to be packaged, said inner layer comprising a polyolefin resin composition with polyolefin resin containing Component A, Component B and Component C in a total amount of 0.15-12 weight %, wherein Component A is one or more selected from the group consisting of partial esters of aliphatic trihydric-hexahydric alcohol and aliphatic monocarboxylic acid with 8-22 carbon atoms, alkylene oxide adducts of aliphatic monohydric alcohol with 8-22 carbon atoms, alkylene oxide adducts of aliphatic monocarboxylic acid with 8-22 carbon atoms and alkylene oxide adducts of partial ester of aliphatic trihydric-hexahydric alcohol and aliphatic monocarboxylic acid with 8-22 carbon atoms; Component B is one or more selected from the group consisting of alkali salts of alkyl sulfonic acid having alkyl group with 6-22 carbon atoms, alkali salts of alkyl aryl sulfonic acid having alkyl group with 2-22 carbon atoms and alkali salts of 1,2-bis(alkyloxycarbonyl)-1-ethane sulfonic acid having alkyl group with 2-22 carbon atoms; and Component C is one or more selected from the group consisting of oxidic inorganic particles, silicate inorganic particles and organic cross-link particles.

2. The packaging film of claim 1 wherein the polyolefin resin of said inner layer contains said Component A in an amount of 0.05-5 weight %, said Component B in an amount of 0.05-5 weight % and said Component C in an amount of 0.05-2 weight %.

3. The packaging film of claim 1 wherein the polyolefin resin of said inner layer contains said Component A in an amount of 0.3-4 weight %, said Component B in an amount of 0.2-2.6 weight % and said Component C in an amount of 0.1-1 weight %, said Component A and said Component B being contained at weight ratio of 60/40-80/20, said Component C being contained at weight ratio of 10/100-100/100 with respect to the sum of said Component A and said Component B.

4. The packaging film of claim 3 wherein said Component A is partial ester of aliphatic trihydric or tetrahydric alcohol and aliphatic monocarboxylic acid with 12-18 carbon atoms.

5. The packaging film of claim 3 wherein said Component A is partial ester of aliphatic trihydric-hexahydric alcohol and aliphatic monocarboxylic acid with 8-22 carbon atoms, said partial ester having a melting point of 40° C. or below.

6. The packaging film of claim 3 wherein said Component B is alkali salt of alkylsulfonic acid having alkyl group with 12-18 carbon atoms.

7. The packaging film of claim 4 wherein said Component B is alkali salt of alkylsulfonic acid having alkyl group with 12-18 carbon atoms.

8. The packaging film of claim 5 wherein said Component B is alkali salt of alkylsulfonic acid having alkyl group with 12-18 carbon atoms.

9. The packaging film of claim 3 wherein said Component C is at least one selected from the group consisting of oxidic inorganic particle and silicate inorganic particle.

10. The packaging film of claim 7 wherein said Component C is at least one selected from the group consisting of oxidic inorganic particle and silicate inorganic particle.

11. The packaging film of claim 8 wherein said Component C is at least one selected from the group consisting of oxidic inorganic particle and silicate inorganic particle.

12. The packaging film of claim 3 wherein said Component C is one or more selected from the group consisting of silica, zeolite and talc.

13. The packaging film of claim 7 wherein said Component C is one or more selected from the group consisting of silica, zeolite and talc.

14. The packaging film of claim 8 wherein said Component C is one or more selected from the group consisting of silica, zeolite and talc.
